(19) United States
(12) Patent Application Publication
(10) Pub. No.: US 2026/0029199 A1
(43) Pub. Date: Jan. 29, 2026

(54) DEVICE FOR HAREMLESS TREATMENT OF PHOSPHOGYPSUM BY CALCINATION USING HIGH-TEMPERATURE CERAMSITE

(71) Applicant: Hubei Juhai Environmental Technology Co., Ltd., Wuhan (CN)

(72) Inventor: Zhihao Liu, Wuhan (CN)

(21) Appl. No.: 19/347,835

(22) Filed: Oct. 2, 2025

Related U.S. Application Data
(63) Continuation of application No. PCT/CN2023/115006, filed on Aug. 25, 2023.

(30) Foreign Application Priority Data
Apr. 27, 2023 (CN) 2023104703950

(51) Int. Cl. F27B 7/32; C01F 11/46; F27B 7/02; F27B 7/16; F27B 7/28; F27B 7/33

(52) U.S. Cl. CPC F27B 7/3205; C01F 11/466; F27B 7/161; F27B 7/28; F27B 7/33; F27B 2007/027; F27B 2007/3288

(57) ABSTRACT

The present disclosure relates to the technical field of phosphogypsum dehydration treatment, and provides a device for harmless treatment of phosphogypsum by calcination using high-temperature ceramsite, including a rotary kiln, a first feeding unit, a second feeding unit and a sorting assembly, where the rotary kiln includes a first rotary kiln drum and a second rotary kiln drum; a first interlayer channel is formed between the first rotary kiln drum and the second rotary kiln drum, and a head end of the first interlayer channel is connected to a head end of the first rotary kiln drum; the first feeding unit is used to input high-temperature ceramsite into the first rotary kiln drum; the second feeding unit is used to input phosphogypsum into the first interlayer channel; the mixture in the first rotary kiln drum and the phosphogypsum in the first interlayer channel can exchange heat to dehydrate the phosphogypsum; the sorting assembly is used to sort the mixture output from the first rotary kiln drum to obtain calcined phosphogypsum. The present disclosure enables high calcination and dehydration efficiency of phosphogypsum, and can achieve low-carbon harmless treatment of phosphogypsum to obtain phosphorus building gypsum.

### CROSS-REFERENCE TO RELATED APPLICATIONS

This application claims priority to Chinese Patent Application No. 202310470395.0, filed on Apr. 27, 2023 and entitled “Device for Harmless Treatment of Phosphogypsum by Calcination Using High-Temperature Ceramsite”, the entire contents of which are incorporated herein by reference.

### TECHNICAL FIELD

The present disclosure relates to the technical field of phosphogypsum dehydration treatment, and in particular, to a device for harmless treatment of phosphogypsum by calcination using high-temperature ceramsite.

### BACKGROUND

Phosphogypsum is a by-product from the production of high-concentration phosphate fertilizers through a sulfuric acid process for phosphoric acid production. The main component of phosphogypsum is calcium sulfate dihydrate, which contains impurities such as phosphates, sulfates, fluorides, and heavy metals like manganese and cadmium. During long-term storage of phosphogypsum, natural weather activities such as sunlight, wind, rain, and thunderstorms accelerate the release of soluble phosphorus, fluoride, and heavy metal pollutants. Acidic wastes such as soluble phosphorus in phosphogypsum are soaked and leached out again with rainfall, causing severe damage to water quality, soil, and vegetation in surrounding areas. Therefore, harmless utilization of phosphogypsum is evidently crucial to reduce its pollution to a surrounding environment.

Currently, producing gypsum building materials from phosphogypsum is a primary direction to expand the resource utilization of phosphogypsum. The key step in producing gypsum building materials from phosphogypsum is to calcine and dehydrate phosphogypsum to produce gypsum powder. In related technologies, when phosphogypsum is calcined and dehydrated, a frying pan, a rotary kiln, a fluidized bed furnace and grinding integrated calcining equipment are mainly used, and some harmful impurities can be removed during the dehydration process. However, the existing phosphogypsum calcination equipment still suffers from low calcination and dehydration efficiency, making it difficult to achieve harmless treatment of phosphogypsum to a certain extent.

### SUMMARY OF THE INVENTION

The present disclosure provides a device for harmless treatment of phosphogypsum by calcination using high-temperature ceramsite, which is used to solve the problem of low calcination and dehydration efficiency in existing phosphogypsum calcination equipment, which makes it difficult to achieve harmless treatment of phosphogypsum to a certain extent.

The present disclosure provides a device for harmless treatment of phosphogypsum by calcination using high-temperature ceramsite, including: a rotary kiln, a first feeding unit, a second feeding unit and a sorting assembly.

The rotary kiln includes a first rotary kiln drum and a second rotary kiln drum. The second rotary kiln drum is sleeved onto an outer side of the first rotary kiln drum. A first interlayer channel is formed between the first rotary kiln drum and the second rotary kiln drum, and a head end of the first interlayer channel is connected to a head end of the first rotary kiln drum.

The first feeding unit is connected to the head end of the first rotary kiln drum to input high-temperature ceramsite into the first rotary kiln drum, and the second feeding unit is connected to the first interlayer channel to input phosphogypsum into the first interlayer channel.

The second rotary kiln drum is used to drive phosphogypsum to be delivered along the first interlayer channel to the head end of the first rotary kiln drum, and the first rotary kiln drum is used to drive a mixture composed of phosphogypsum and high-temperature ceramsite to move from the head end to a tail end of the first rotary kiln drum. The mixture in the first rotary kiln drum and the phosphogypsum in the first interlayer channel can exchange heat through a drum wall of the first rotary kiln drum to dehydrate the phosphogypsum.

The sorting assembly is arranged at the tail end of the first rotary kiln drum to sort the mixture output from the first rotary kiln drum to obtain calcined phosphogypsum.

According to the device for harmless treatment of phosphogypsum by calcination using high-temperature ceramsite provided by the present disclosure, an inner wall of the first rotary kiln drum and an inner wall of the second rotary kiln drum are both provided with spirally arranged propulsion blades; and
the first rotary kiln drum and the second rotary kiln drum can rotate at the same speed or different speeds in the same rotation direction.

According to the device for harmless treatment of phosphogypsum by calcination using high-temperature ceramsite provided by the present disclosure, the rotary kiln further includes a kiln head, where
the kiln head is annular and sleeved onto a peripheral wall of the second rotary kiln drum; a feeding chamber is formed between the kiln head and the peripheral wall of the second rotary kiln drum; a communication port is provided in the peripheral wall of the second rotary kiln drum, and the feeding chamber is connected to the first interlayer channel through the communication port; and
the second feeding unit is connected to the kiln head to input the phosphogypsum into the feeding chamber.

According to the device for harmless treatment of phosphogypsum by calcination using high-temperature ceramsite provided by the present disclosure, a plurality of second rotary kiln drums are provided.

The plurality of second rotary kiln drums are sequentially sleeved onto outer side of the first rotary kiln drum, a second interlayer channel is formed between every adjacent two second rotary kiln drums, and a plurality of second interlayer channels are sequentially connected to the first interlayer channel in an end-to-end manner from outside to inside, forming a serpentine runner.

The kiln head is sleeved onto a peripheral wall of the one among the plurality of the second rotary kiln drums in the outermost layer, and the feeding chamber is formed between the kiln head and the one among the plurality of the second rotary kiln drums in the outermost layer. A communication port is provided in the peripheral wall of the one among the plurality of the second rotary kiln drums in the outermost layer, and the feeding chamber is connected to the serpentine runner through the communication port.

The phosphogypsum convoyed by the second feeding unit can be delivered along the serpentine runner and finally reach inside the first rotary kiln drum.

According to the device for harmless treatment of phosphogypsum by calcination using high-temperature ceramsite provided by the present disclosure, when the number of the second rotary kiln drums is odd, the kiln head is arranged at a tail end of the one among the plurality of second rotary kiln drums in the outermost layer; and
when the number of the second rotary kiln drums is even, the kiln head is arranged at a head end of the one among the second rotary kiln drums in the outermost layer.

According to the device for harmless treatment of phosphogypsum by calcination using high-temperature ceramsite provided by the present disclosure, a propulsion mechanism is provided in the feeding chamber, where
the propulsion mechanism is used to drive the phosphogypsum in the feeding chamber into the first interlayer channel through the communication port.

According to the device for harmless treatment of phosphogypsum by calcination using high-temperature ceramsite provided by the present disclosure, the device further includes: an induced-draft assembly, where
one end of the induced-draft assembly is connected to the tail end of the first rotary kiln drum, and the other end is connected to the feeding chamber; and
the induced-draft assembly is used to drive a hot air output from the tail end of the first rotary kiln drum to flow back into the feeding chamber.

According to the device for harmless treatment of phosphogypsum by calcination using high-temperature ceramsite provided by the present disclosure, the induced-draft assembly includes a filter assembly and an induced draft fan.

The tail end of the first rotary kiln drum is connected to an air inlet end of the induced draft fan through the filter assembly, and an air outlet end of the induced draft fan is connected to the feeding chamber.

According to the device for harmless treatment of phosphogypsum by calcination using high-temperature ceramsite provided by the present disclosure, the induced-draft assembly includes a cyclone separator and an induced draft fan. The tail end of the first rotary kiln drum is connected to an air inlet end on a side wall of the cyclone separator, an air outlet end at the top of the cyclone separator is connected to an air inlet end of the induced draft fan, an air outlet end of the induced draft fan is connected to the feeding chamber, and a bottom end of the cyclone separator is used to discharge separated solid impurities.

According to the device for harmless treatment of phosphogypsum by calcination using high-temperature ceramsite provided by the present disclosure, the sorting assembly includes a first discharge channel, a sorting screen, a second discharge channel and a discharge hopper.

The tail end of the first rotary kiln drum is connected to one end of the first discharge channel, and the other end of the first discharge channel extends to a screen surface of the sorting screen.

An oversized material screened out by the sorting screen is discharged through the second discharge channel, and an undersize material screened out by the sorting screen is discharged through the discharge hopper.

According to the device for harmless treatment of phosphogypsum by calcination using high-temperature ceramsite provided by the present disclosure, by configuring the rotary kiln, the first feeding unit, the second feeding unit, and the sorting assembly, the high-temperature ceramsite can be input into the head end of the first rotary kiln drum through the first feeding unit, and the phosphogypsum can be input into the first interlayer channel through the second feeding unit. Under the rotation of the first rotary kiln drum and the second rotary kiln drum, the phosphogypsum is delivered into the head end of the first rotary kiln drum along the first interlayer channel and mixed with the high-temperature ceramsite. On one hand, the high-temperature ceramsite passivates harmful gases generated during the high-temperature dehydration of the phosphogypsum. By utilizing the porous adsorption property of the high-temperature ceramsite, it can absorb water vapor generated by the instantaneous vaporization of the phosphogypsum due to heating when coming into contact with the phosphogypsum, which achieves negative pressure sorting of the phosphogypsum. This can achieve flash calcination of phosphogypsum while reducing dust. As the first rotary kiln drum transports the mixture of phosphogypsum and high-temperature ceramsite, the high-temperature ceramsite allows for heat exchange between the mixture in the first rotary kiln drum and the phosphogypsum in the first interlayer channel through the drum wall of the first rotary kiln drum, dehydrating the phosphogypsum continuously delivered in the first interlayer channel at high temperature. In addition, after the flash calcination of the phosphogypsum by the high-temperature ceramsite, the phosphogypsum can be further calcined by utilizing residual heat of the high-temperature ceramsite during the transportation of the mixture. Finally, the mixture output from the first rotary kiln drum can be sorted by the sorting assembly to achieve separation of large-particle ceramsite from fine particles of phosphorus building gypsum.

It can be seen from the above that the device shown in the present disclosure can make full use of the high-temperature ceramsite to heat the phosphogypsum, and adsorb harmful substances and water vapor generated during dehydration of the phosphogypsum, which enable high calcination and dehydration efficiency of phosphogypsum based on the rotary kiln, and achieve low-carbon harmless treatment of phosphogypsum to obtain phosphorus building gypsum.

### BRIEF DESCRIPTION OF THE DRAWINGS

In order to describe the technical solutions in the present disclosure or in the prior art more clearly, a brief introduction will be given below to the accompanying drawings required for describing the embodiments or the prior art. It is evident that the accompanying drawings in the following description are some embodiments of the present disclosure. For those of ordinary skill in the art, other accompanying drawings can be obtained based on these accompanying drawings without creative efforts.

FIG. 1 is a first structural schematic diagram of a device for harmless treatment of phosphogypsum by calcination using high-temperature ceramsite provided by the present disclosure.

FIG. 2 is a structural schematic diagram of the rotary kiln in FIG. 1 provided by the present disclosure.

FIG. 3 is a second structural schematic diagram of a device for harmless treatment of phosphogypsum by calcination using high-temperature ceramsite provided by the present disclosure.

FIG. 4 is a third structural schematic diagram of a device for harmless treatment of phosphogypsum by calcination using high-temperature ceramsite provided by the present disclosure.

FIG. 5 is a structural schematic diagram of the rotary kiln in FIG. 4 provided by the present disclosure.

FIG. 6 is a fourth structural schematic diagram of a device for harmless treatment on phosphogypsum by calcination using high-temperature ceramsite provided by the present disclosure.

FIG. 7 is a structural schematic diagram of the rotary kiln in FIG.6 provided by the present disclosure.

### REFERENCE NUMERALS IN THE DRAWINGS

11. Rotary kiln; 11. First rotary kiln drum; 12. Second rotary kiln drum; 13. Kiln head; 101. Propulsion blade; 111. First interlayer channel; 112. Second interlayer channel;

2. First feeding unit; 3. Second feeding unit;

4. Sorting assembly; 41. First discharge channel; 42. Sorting screen; 43. Second discharge channel; 44. Discharge hopper;

5. Induced-draft assembly; 51. Filter assembly; 52. Induced draft fan; 53. Cyclone separator.

### DETAILED DESCRIPTION OF THE EMBODIMENTS

In order to make the objectives, technical solutions and advantages of the present disclosure more clearly, the following clearly and completely describes the technical solutions in the present disclosure with reference to the accompanying drawings in the present disclosure. Apparently, the described embodiments are a part, rather than, all the embodiments of the present disclosure. All other embodiments obtained by those of ordinary skill in the art based on the embodiments of the present disclosure without creative efforts shall fall within the protection scope of the present disclosure.

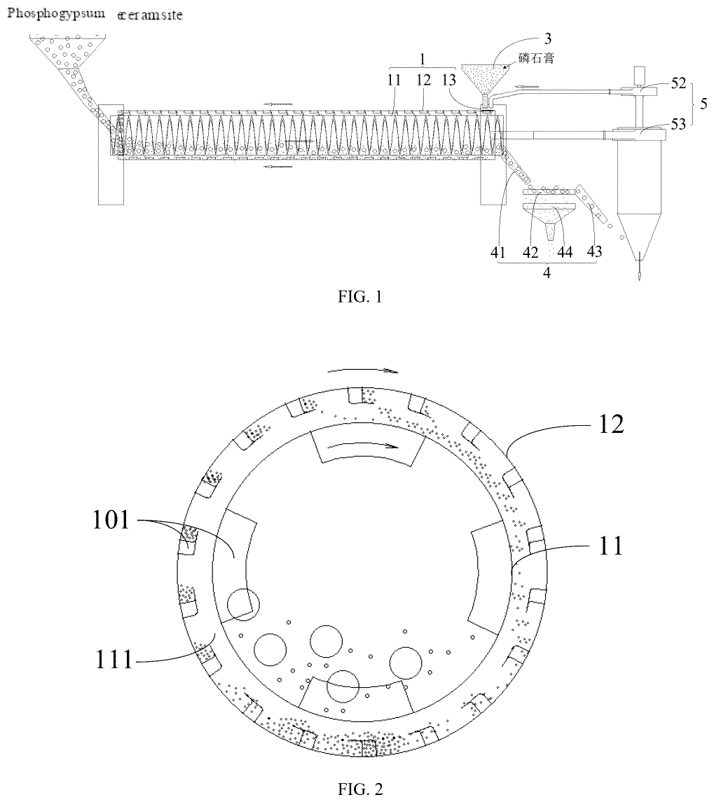

A device for harmless treatment of phosphogypsum by calcination using high-temperature ceramsite provided by embodiments of the present disclosure will be described in detail below through specific embodiments and their application scenarios with reference to FIG. 1 to FIG. 7.

As shown in FIG. 1 to FIG. 7, the embodiments of the present disclosure provide a device for harmless treatment of phosphogypsum by calcination using high-temperature ceramsite, including: a rotary kiln 1, a first feeding unit 2, a second feeding unit 3, and a sorting assembly 4.

The rotary kiln 1 includes a first rotary kiln drum 11 and a second rotary kiln drum 12, the second rotary kiln drum 12 is sleeved onto an outer side of the first rotary kiln drum 11, a first interlayer channel 111 is formed between the first rotary kiln drum 11 and the second rotary kiln drum 12, and a head end of the first interlayer channel 111 is connected to a head end of the first rotary kiln drum 11.

The first feeding unit 2 is connected to the head end of the first rotary kiln drum 11 to input high-temperature ceramsite into the first rotary kiln drum 11, and the second feeding unit 3 is connected to the first interlayer channel 111 to input phosphogypsum into the first interlayer channel 111.

The second rotary kiln drum 12 is used to drive the phosphogypsum to be delivered along the first interlayer channel 111 to the head end of the first rotary kiln drum 11. The first rotary kiln drum 11 is used to drive a mixture composed of phosphogypsum and high-temperature ceramsite to move from the head end to a tail end of the first rotary kiln drum 11. The mixture in the first rotary kiln drum 11 and the phosphogypsum in the first interlayer channel 111 can exchange heat through a drum wall of the first rotary kiln drum 11 to dehydrate the phosphogypsum.

The sorting assembly 4 is disposed at the tail end of the first rotary kiln drum 11 to sort the mixture output from the first rotary kiln drum 11 to obtain calcined phosphogypsum.

It can be understood that the phosphogypsum of this embodiment can specifically be a phosphogypsum premix with a temperature above 60° C., a free water content ≤10%, and an organic matter content of 5-20 wt %.

The high-temperature ceramsite of this embodiment is specifically a ceramsite with a temperature >800° C. and having an open flame. Optionally, the ceramsite has a density ≤1,200 kg/m³, an average particle size <31.5 mm, and a porosity >30%.

In some examples, the first feeding unit 2 and the second feeding unit 3 of this embodiment may both be configured as bucket-shaped structures.

In some examples, both the first rotary kiln drum 11 and the second rotary kiln drum 12 corresponding to the rotary kiln 1 can be regarded as being provided with rotary drive mechanisms to enable the first rotary kiln drum 11 and the second rotary kiln drum 12 to rotate at the same speed or different speeds in the same rotation direction. An inner wall of the first rotary kiln drum 11 and an inner wall of the second rotary kiln drum 12 are both provided with material conveying structures.

As the first rotary kiln drum 11 and the second rotary kiln drum 12 rotate, the phosphogypsum conveyed into the first interlayer channel 111 by the second feeding unit 3 can be gradually delivered to the head end of the first rotary kiln drum 11 under the drive of the material conveying structure on the inner wall of the second rotary kiln drum 12; Correspondingly, the mixture composed of phosphogypsum and high-temperature ceramsite can be gradually moved from the head end to the tail end of the first rotary kiln drum 11 under the drive of the material conveying structure on the inner wall of the first rotary kiln drum 11.

In some examples, the sorting assembly 4 can be understood as an assembly with a screen structure, and is used to receive the mixture output from the tail end of the first rotary kiln drum 11. The sorting assembly 4 can process the mixture output from the first rotary kiln drum 11 by screening, resulting in an oversize material being large-particle ceramsite and an undersize material being fine particles of phosphorus building gypsum.

According to the present invention, by configuring the rotary kiln 1, the first feeding member 2, the second feeding member 3, and the sorting assembly 4, high-temperature ceramsite can be input into the head end of the first rotary kiln drum 11 through the first feeding unit 2, and phosphogypsum can be input into the first interlayer channel 111 through the second feeding unit 3. Under the rotation of the first rotary kiln drum 11 and the second rotary kiln drum 12, the phosphogypsum is delivered into the head end of the first rotary kiln drum 11 along the first interlayer channel 111 and mixed with the high-temperature ceramsite. On one hand, the high-temperature ceramsite passivates harmful gases generated during the high-temperature dehydration of the phosphogypsum. By utilizing the porous adsorption property of the high-temperature ceramsite, it can absorb water vapor generated by the instantaneous vaporization of the phosphogypsum due to heating when coming into contact with the phosphogypsum, which realize negative pressure sorting of phosphogypsum. This can achieve flash calcination of phosphogypsum while reducing dust. As the first rotary kiln drum 11 deliveries the mixture of phosphogypsum and high-temperature ceramsite, the high-temperature ceramsite allows for heat exchange between the mixture in the first rotary kiln drum 11 and the phosphogypsum in the first interlayer channel 111 through the drum wall of the first rotary kiln drum 11, dehydrating the phosphogypsum continuously delivered in the first interlayer channel 111 at high temperature. In addition, after the flash calcination of the phosphogypsum by the high-temperature ceramsite, the phosphogypsum can be further calcined by utilizing residual heat of the high-temperature ceramsite during delivery of the mixture. Finally, the mixture output from the first rotary kiln drum 11 can be sorted by the sorting assembly 4 to achieve separation of large-particle ceramsite from fine particles of phosphorus building gypsum.

It can be seen from the above that the device shown in the present disclosure can make full use of the high-temperature ceramsite to heat the phosphogypsum, and adsorb harmful substances and water vapor generated during dehydration of the phosphogypsum. High calcination and dehydration efficiency of the phosphogypsum can be achieved based on the rotary kiln 1, low-carbon harmless treatment of the phosphogypsum can be achieved, and phosphorus building gypsum is produced.

In some embodiments, as shown in FIG. 1 to FIG. 7, an inner wall of the first rotary kiln drum 11 and an inner wall of the second rotary kiln drum 12 are both provided with spirally arranged propulsion blades 101.

The first rotary kiln drum 11 and the second rotary kiln drum 12 can rotate at the same speed or different speeds in the same rotation direction.

Thus, when the first rotary kiln drum 11 rotates, the first rotary kiln drum 11 can drive the propulsion blades 101 on the inner wall of the first rotary kiln drum 11 to rotate, thereby guiding the mixture to move from the head end to the tail end of the first rotary kiln drum 11 based on the propulsion blades 101.

Similarly, when the second rotary kiln drum 12 rotates, the second rotary kiln drum 12 can drive the propulsion blades 101 on the inner wall of the second rotary kiln drum 12 to rotate, thereby guiding the phosphogypsum to move from the tail end to the head end of the first interlayer channel 111 based on the propulsion blades 101, reach the head end of the first rotary kiln drum 11 and mix with the high-temperature ceramsite.

In practical applications, this embodiment can control the rotational speed of the first rotary kiln drum 11 and the second rotary kiln drum 12 to regulate the propulsion speed of the materials in their respective chambers of the first rotary kiln drum 11 and the second rotary kiln drum 12.

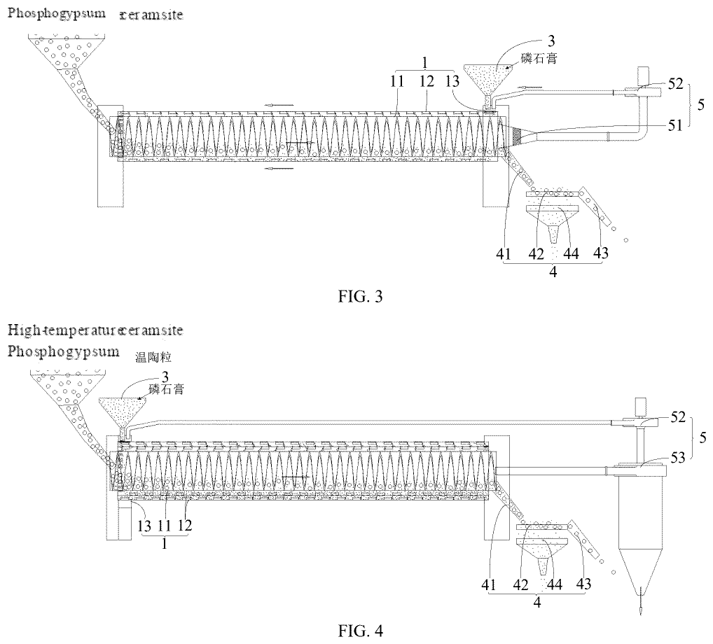

In some embodiments, as shown in FIG. 1 and FIG. 3, the rotary kiln 1 further includes a kiln head 13, where the kiln head 13 is annular and sleeved onto the peripheral wall of the second rotary kiln drum 12. A feeding chamber is formed between the kiln head 13 and the peripheral wall of the second rotary kiln drum 12. A communication port is provided in the peripheral wall of the second rotary kiln drum 12, and the feeding chamber is connected to the first interlayer channel 111 through the communication port. The second feeding unit 3 is connected to the kiln head 13 to input the phosphogypsum into the feeding chamber.

It can be understood that the kiln head 13 in this embodiment is fixedly arranged, and a sliding seal is achieved between the inner wall surface of the kiln head 13 and the peripheral wall of the second rotary kiln drum 12 to form a closed feeding chamber between the kiln head 13 and the peripheral wall of the second rotary kiln drum 12.

The communication port in this embodiment can be configured to extend along an extension direction of the kiln head 13, so that after the second feeding unit 3 inputs the phosphogypsum into the feeding chamber, the phosphogypsum in the feeding chamber can enter the first interlayer channel 111 through the communication port.

Obviously, based on the arrangement of the kiln head 13, this embodiment facilitates the feeding of the second feeding unit 3 into the second rotary kiln drum 12 rotatably arranged.

In some embodiments, as shown in FIG. 4 to FIG. 7, a plurality of the second rotary kiln drums 12 are provided. The plurality of the second rotary kiln drums 12 are sequentially sleeved onto the outer side of the first rotary kiln drum 11, and a second interlayer channel 112 is formed between every adjacent two second rotary kiln drums 12. A plurality of second interlayer channels 112 are sequentially connected to the first interlayer channel 111 in an end-to-end manner from outside to inside to form a serpentine runner.

The kiln head 13 is sleeved onto a peripheral wall of the outermost layer of the plurality of the second rotary kiln drums 12, and a feeding chamber is formed between the kiln head 13 and the one among the plurality of the second rotary kiln drums 12 in the outermost layer. A communication port is provided in the peripheral wall of the one among the plurality of the second rotary kiln drums 12 in the outermost layer, and the feeding chamber is connected to the serpentine runner through the communication port.

The phosphogypsum conveyed by the second feeding unit 3 can be delivered along the serpentine runner and finally reach inside the first rotary kiln drum 11.

It can be understood that by sequentially sleeving the plurality of the second rotary kiln drums 12 onto the outer side of the first rotary kiln drum 11, this embodiment allows the multi-layer second interlayer channels 112 to be sequentially formed on the outer side of the first interlayer channel 111 from inside to outside.

The tail end of the first interlayer channel 111 is connected to the head end of the first rotary kiln drum 11, the head end of the first interlayer channel 111 is connected to the tail end of the first innermost layer of the multi-layer second interlayer channels 112, the head end of the first innermost layer of the multi-layer second interlayer channels 112 is connected to the tail end of the second innermost layer of the multi-layer second interlayer channels 112, the head end of the second innermost layer of the multi-layer second interlayer channels 112 is connected to the tail end of the third innermost layer of the multi-layer second interlayer channels 112, and so on. The outermost layer of the multi-layer second interlayer channels 112 is connected to the feeding chamber through the communication port.

Along the direction of material conveying in the first rotary kiln drum 11, the head end of the first rotary kiln drum 11 is located at an upstream of the tail end of the first rotary kiln drum 11; along the direction of material conveying in the first interlayer channel 111, the head end of the first interlayer channel 111 is located at an upstream of the tail end of the first interlayer channel 111; and along the direction of material conveying in the second interlayer channel 112, the head end of the second interlayer channel 112 is located at an upstream of the tail end of the second interlayer channel 112.

As the first rotary kiln drum 11 and the plurality of second rotary kiln drums 12 rotate, the phosphogypsum convoyed to the feeding chamber through the second feeding unit 3 can be delivered along the above-mentioned serpentine runner layer by layer from the interlayer channel in an outer layer to the interlayer channel in an inner layer until it reaches inside the first rotary kiln drum 11.

Obviously, during delivery of the phosphogypsum layer by layer, the phosphogypsum in the first interlayer channel 111 or the second interlayer channel 112 can exchange heat with the mixture in the first rotary kiln drum 11. This allows for dehydration of the phosphogypsum during its delivery layer by layer, effectively utilizing the thermal energy of the high-temperature ceramsite. Therefore, effective dehydration of the phosphogypsum is ensured and energy is saved.

In some embodiments, when the number of the second rotary kiln drums 12 is odd, the kiln head 13 is disposed at the tail end of the one among the second rotary kiln drums 12 in the outermost layer.

When the number of the second rotary kiln drums 12 is even, the kiln head 13 is disposed at the head end of the one among the second rotary kiln drums 12 in the outermost layer.

In this embodiment, based on the position setting of the kiln head 13, the length of the serpentine runner formed by the second interlayer channel 112 and the first interlayer channel 111 can be ensured, which is conducive to extending the time for conveying phosphogypsum along the serpentine runner as much as possible, thereby achieving effective dehydration of phosphogypsum during delivery.

As shown in FIG. 1 to FIG. 3, one second rotary kiln drum 12 is provided, and the kiln head 13 is provided at the tail end of the second rotary kiln drum 12. In this case, only the first interlayer channel 111 is provided between the first rotary kiln drum 11 and the second rotary kiln drum 12.

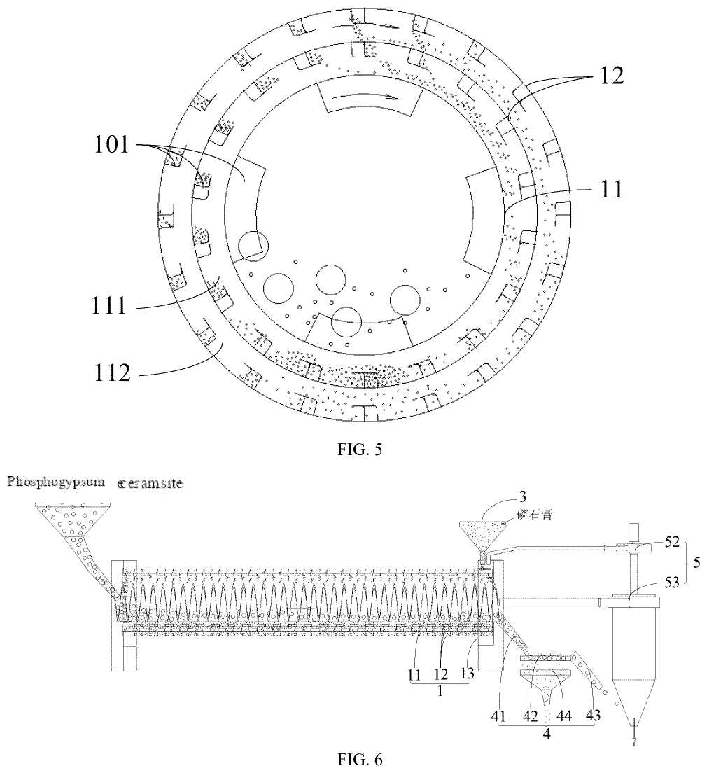

As shown in FIG. 4 and FIG. 5, two second rotary kiln drums 12 are provided, and the kiln head 13 is provided at the head end of the one of the two second rotary kiln drums 12 in the outermost layer. In this case, the first interlayer channel 111 is provided between the first rotary kiln drum 11 and the second rotary kiln drum 12 in the inner layer, and the second interlayer channel 112 is provided between the second rotary kiln drum 12 in the inner layer and the second rotary kiln drum 12 in the outer layer.

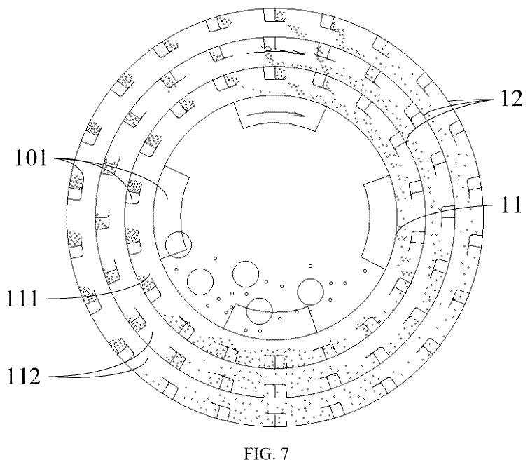

As shown in FIG. 6 and FIG. 7, three second rotary kiln drums 12 are provided, and the kiln head 13 is provided at the tail end of the one of the three second rotary kiln drums 12 in the outermost layer. In this case, the first interlayer channel 111 is provided between the first rotary kiln drum 11 and the first innermost layer among the three second rotary kiln drums 12, and each of the second interlayer channels 112 is provided between the first innermost first layer among the three second rotary kiln drums 12 and the second innermost layer among the three second rotary kiln drums 12, and between the second innermost layer of the three second rotary kiln drums 12 and the outermost layer among the three second rotary kiln drums 12.

In some embodiments, a propulsion mechanism is provided in the above feeding chamber. The propulsion mechanism is used to drive the phosphogypsum in the feeding chamber into the first interlayer channel 111 through the communication port.

The propulsion mechanism may be a screw propeller, which may be disposed between the discharge end of the second feeding unit 3 and the communication port. The screw propeller may be configured coaxially with the discharge direction of the second feeding unit 3, thereby facilitating the propulsion of the phosphogypsum output from the second feeding unit 3 into the communication port.

Alternatively, the propulsion mechanism can also be configured to include a telescopic drive component and a push plate, where the output end of the telescopic drive component is connected to the push plate, and the telescopic drive unit is used to drive the push plate to reciprocate, pushing the phosphogypsum in the feeding chamber into the communication port.

In some embodiments, as shown in FIG. 1 and FIG. 3, the device shown in this embodiment is further provided with an induced-draft assembly 5, where one end of the induced-draft assembly 5 is connected to the tail end of the first rotary kiln drum 11, and the other end is connected to the feeding chamber.

The induced-draft assembly 5 is used to drive the hot air output from the tail end of the first rotary kiln drum 11 to flow back into the feeding chamber.

It can be understood that, in this embodiment, the hot air output from the tail end of the first rotary kiln drum 11 can flow back into the feeding chamber under the drive of the induced-draft assembly 5. After entering the feeding chamber, this hot air can enter the serpentine runner through the communication port. The hot air undergoes convective heat exchange with the phosphogypsum delivered in the serpentine runner, and then enters the head end of the first rotary kiln drum 11, and finally reaches the tail end of the first rotary kiln drum 11 along with the mixture delivered in the first rotary kiln drum 11, thereby forming a cyclic air path, and repeatedly operating in this manner.

Obviously, based on the arrangement of the induced-draft assembly 5, this embodiment can effectively utilize the hot air output from the tail end of the first rotary kiln drum 11, thereby heating the phosphogypsum delivered into the first rotary kiln drum 11 using the residual heat of the hot air. In addition, the hot air also undergoes convective heat exchange with the phosphogypsum during delivery along the serpentine runner, which is beneficial to improving the heat exchange efficiency both inside and outside the first rotary kiln drum 11, thereby enhancing the dehydration effect on the phosphogypsum.

In some embodiments, as shown in FIG. 3, the induced-draft assembly 5 includes a filter assembly 51 and an induced draft fan 52.

The tail end of the first rotary kiln drum 11 is connected to the air inlet end of the induced draft fan 52 through the filter assembly 51, and the air outlet end of the induced draft fan 52 is connected to the feeding chamber.

Specifically, the tail end of the first rotary kiln drum 11 is connected to a first end of a first air duct, a second end of the first air duct is connected to the air inlet end of the induced draft fan 52, the air outlet end of the induced draft fan 52 is connected to a first end of a second air duct, and a second end of the second air duct is connected to the feeding chamber.

Under the drive of the induced draft fan 52, the hot air output from the tail end of the first rotary kiln drum 11 sequentially passes through the filter assembly 51 and the induced draft fan 52, and then enters the rotary kiln 1 through the feeding chamber, thereby forming a cyclic air path.

The filter assembly 51 is disposed at the first end of the first air duct and includes a filter screen and a vibrator, where the vibrator is connected to the filter screen. The vibration action of the vibrator can prevent dust from accumulating on the filter screen.

In actual applications, the first end of the first air duct can be configured as a trumpet-shaped air outlet, the filter screen is disposed in the trumpet-shaped air outlet, and the vibrator is disposed on one side of the filter screen facing the first rotary kiln drum 11. In this way, when dust accumulates on the filter screen, the vibrator is activated, and the dust accumulated on the filter screen can fall off due to the vibration of the vibrator and then falls back into the first rotary kiln drum 11 along the trumpet-shaped air outlet.

In some embodiments, as shown in FIG. 1, FIG. 4 and FIG. 6, the induced-draft assembly 5 includes a cyclone separator 53 and the induced draft fan 52. The tail end of the first rotary kiln drum 11 is connected to the air inlet end on the side wall of the cyclone separator 53, the air outlet end at the top of the cyclone separator 53 is connected to the air inlet end of the induced draft fan 52, the air outlet end of the induced draft fan 52 is connected to the feeding chamber, and the bottom end of the cyclone separator 53 is used to discharge separated solid impurities.

It can be understood that, under the drive of the induced draft fan 52, the hot air output from the tail end of the first rotary kiln drum 11 is radially introduced into the cyclone drum corresponding to the cyclone separator 53, and rotates along the inner wall of the cyclone drum. During this process, large-particle solid impurities gradually reach the bottom end of the cyclone separator 53, and are discharged from the bottom end of the cyclone separator 53. Small-particle dust enters the induced draft fan 52 along with the hot air, and then travels through the air duct to the rotary kiln 1, thereby forming a cyclic air path.

Obviously, in this embodiment, by configuring the induced draft assembly 5 with the cyclone separator 53 or the filter assembly 51, solid impurities in the hot air can be effectively separated during the hot air circulation process, thereby facilitating the purification of the phosphogypsum while utilizing the hot air to heat and dehydrate the phosphogypsum.

In some embodiments, as shown in FIG. 1, FIG. 3, FIG. 4 and FIG. 5, the sorting assembly 4 includes a first discharge channel 41, a sorting screen 42, a second discharge channel 43, and a discharge hopper 44.

The tail end of the first rotary kiln drum 11 is connected to one end of the first discharge channel 41, and the other end of the first discharge channel 41 extends to a screen surface of the sorting screen 42.

An oversize material screened out by the sorting screen 42 is discharged through the second discharge channel 43, and an undersize material screened out by the sorting screen 42 is discharged through the discharge hopper 44.

Specifically, the sorting screen 42 can be configured to be inclined. The tail end of the first rotary kiln drum 11 is connected to a first end of the first discharge channel 41, and a second end of the first discharge channel 41 slopes downwards and extends towards the screen surface of the sorting screen 42.

A first end of the second discharge channel 43 is connected to an oversize material outlet end of the sorting screen 42, and the second discharge channel 43 is inclined downwards, so that the oversize material screened out by the sorting screen 42 is discharged from the second end of the second discharge channel 43 under the action of its own weight.

The discharge hopper 44 is provided at the lower side of the sorting screen 42 to receive the undersize material screened out by the sorting screen 42. The undersize material received in the discharge hopper 44 is discharged from a discharge port at its bottom end.

In this embodiments, the main component of the oversize material screened out by the sorting screen 42 is large-particle ceramsite, and the undersize material screened out by the sorting screen 42 is usually powdered phosphorus building gypsum.

Finally, it should be noted that the above embodiments are only used for illustrating the technical solutions of the present disclosure, but are not intended to limit them. Although the present disclosure has been described in detail with reference to the foregoing embodiments, it will be understood by those having ordinary skills in the art that modifications may be still made to the technical solutions described in the foregoing embodiments, or equivalent replacements may be made to some of the technical features. These modifications or replacements do not make the essence of corresponding technical solutions depart from the spirit and scope of the technical solutions of the embodiments of the present disclosure.

### INDUSTRIAL APPLICABILITY

The present disclosure provides a device for harmless treatment of phosphogypsum by calcination using high-temperature ceramsite, including a rotary kiln, a first feeding unit, a second feeding unit and a sorting assembly, where the rotary kiln includes a first rotary kiln drum and a second rotary kiln drum; a first interlayer channel is formed between the first rotary kiln drum and the second rotary kiln drum, and a head end of the first interlayer channel is connected to a head end of the first rotary kiln drum; the first feeding unit is used to input high-temperature ceramsite into the first rotary kiln drum; the second feeding unit is used to input phosphogypsum into the first interlayer channel; the mixture in the first rotary kiln drum and the phosphogypsum in the first interlayer channel can exchange heat to dehydrate the phosphogypsum; the sorting assembly is used to sort the mixture output from the first rotary kiln drum to obtain calcined phosphogypsum. The present disclosure achieves high calcination and dehydration efficiency of phosphogypsum, can enable low-carbon harmless treatment of phosphogypsum to produce phosphorus building gypsum, which has good economic value and application prospects.

What is claimed is:

1. A device for harmless treatment of phosphogypsum by calcination using high-temperature ceramsite, including: a rotary kiln, a first feeding unit, a second feeding unit, and a sorting assembly, wherein
the rotary kiln includes a first rotary kiln drum and a second rotary kiln drum; the second rotary kiln drum is sleeved onto an outer side of the first rotary kiln drum; a first interlayer channel is formed between the first rotary kiln drum and the second rotary kiln drum, and a head end of the first interlayer channel is connected to a head end of the first rotary kiln drum;
the first feeding unit is connected to the head end of the first rotary kiln drum to input high-temperature ceramsite into the first rotary kiln drum; the second feeding unit is connected to the first interlayer channel to input phosphogypsum into the first interlayer channel;
the second rotary kiln drum is used to drive the phosphogypsum to be delivered along the first interlayer channel to the head end of the first rotary kiln drum, and the first rotary kiln drum is used to drive a mixture composed of the phosphogypsum and the high-temperature ceramsite to move from the head end to a tail end of the first rotary kiln drum; the mixture in the first rotary kiln drum and the phosphogypsum in the first interlayer channel can exchange heat through a drum wall of the first rotary kiln drum to dehydrate the phosphogypsum; and
the sorting assembly is arranged at the tail end of the first rotary kiln drum to sort the mixture output from the first rotary kiln drum, obtaining calcined phosphogypsum.

2. The device for harmless treatment of phosphogypsum by calcination using high-temperature ceramsite according to claim 1, wherein an inner wall of the first rotary kiln drum and an inner wall of the second rotary kiln drum are both provided with spirally arranged propulsion blades; and
both the first rotary kiln drum and the second rotary kiln drum can rotate at the same speed or different speeds in the same rotation direction.

3. The device for harmless treatment of phosphogypsum by calcination using high-temperature ceramsite according to claim 1, wherein the rotary kiln further includes a kiln head;
the kiln head is annular and sleeved onto a peripheral wall of the second rotary kiln drum; a feeding chamber is formed between the kiln head and the peripheral wall of the second rotary kiln drum; a communication port is provided in the peripheral wall of the second rotary kiln drum, and the feeding chamber is connected to the first interlayer channel through the communication port; and
the second feeding unit is connected to the kiln head to input the phosphogypsum into the feeding chamber.

4. The device for harmless treatment of phosphogypsum by calcination using high-temperature ceramsite according to claim 3, wherein a plurality of second rotary kiln drums are provided;
the plurality of second rotary kiln drums are sequentially sleeved onto an outer side of the first rotary kiln drum, a second interlayer channel is formed between every adjacent two second rotary kiln drums, and a plurality of second interlayer channels are sequentially connected to the first interlayer channel in an end-to-end manner from outside to inside to form a serpentine runner;
the kiln head is sleeved onto a peripheral wall of the one among the plurality of the second rotary kiln drums in the outermost layer, and the feeding chamber is formed between the kiln head and the one among the plurality of the second rotary kiln drums in the outermost layer; a communication port is provided in the peripheral wall of the one among the plurality of the second rotary kiln drums in the outermost layer, and the feeding chamber is connected to the serpentine runner through the communication port; and
the phosphogypsum conveyed by the second feeding unit can be delivered along the serpentine runner and finally reach inside the first rotary kiln drum.

5. The device for harmless treatment of phosphogypsum by calcination using high-temperature ceramsite according to claim 4, wherein when the number of the second rotary kiln drums is odd, the kiln head is arranged at a tail end of the one among the plurality of the second rotary kiln drums in the outermost layer; and
when the number of the second rotary kiln drums is even, the kiln head is arranged at a head end of the one among the second rotary kiln drums in the outermost layer.

6. The device for harmless treatment of phosphogypsum by calcination using high-temperature ceramsite according to claim 3, wherein a propulsion mechanism is provided in the feeding chamber; and
the propulsion mechanism is used to drive the phosphogypsum in the feeding chamber into the first interlayer channel through the communication port.

7. The device for harmless treatment of phosphogypsum by calcination using high-temperature ceramsite according to claim 3, further including: an induced-draft assembly, wherein
one end of the induced-draft assembly is connected to the tail end of the first rotary kiln drum, and the other end is connected to the feeding chamber; and
the induced-draft assembly is used to drive a hot air output from the tail end of the first rotary kiln drum to flow back into the feeding chamber.

8. The device for harmless treatment of phosphogypsum by calcination using high-temperature ceramsite according to claim 7, wherein the induced-draft assembly includes a filter assembly and an induced draft fan; and
the tail end of the first rotary kiln drum is connected to an air inlet end of the induced draft fan through the filter assembly, and an air outlet end of the induced draft fan is connected to the feeding chamber.

9. The device for harmless treatment of phosphogypsum by calcination using high-temperature ceramsite according to claim 7, wherein the induced-draft assembly includes a cyclone separator and the induced draft fan; the tail end of the first rotary kiln drum is connected to an air inlet end on a side wall of the cyclone separator, an air outlet end at the top of the cyclone separator is connected to an air inlet end of the induced draft fan, the air outlet end of the induced draft fan is connected to the feeding chamber, and a bottom end of the cyclone separator is used to discharge separated solid impurities.

10. The device for harmless treatment of phosphogypsum by calcination using high-temperature ceramsite according to claim 1, wherein the sorting assembly includes a first discharge channel, a sorting screen, a second discharge channel and a discharge hopper;
the tail end of the first rotary kiln drum is connected to one end of the first discharge channel, and the other end of the first discharge channel extends to a screen surface of the sorting screen; and
an oversize material screened out by the sorting screen is discharged through the second discharge channel, and an undersize material screened out by the sorting screen is discharged through the discharge hopper.
